(19) United States
(12) Patent Application Publication
(10) Pub. No.: US 2025/0110725 A1
(43) Pub. Date: Apr. 3, 2025

(54) FAST UPGRADE FOR MULTIPLE EDGE SITES IN A RAN

(71) Applicant: VMware, LLC, Palo Alto, CA (US)

(72) Inventors: Jian Lan, Beijing (CN); Leon Cui, Beijing (CN); Weiqing Wu, Cupertino, CA (US); Uday Suresh Masurekar, Sunnyvale, CA (US); Yan Qi, Beijing (CN); Qi Wang, Beijing (CN); Todd Sabin, Morganville, NJ (US); Aravind Srinivasan, Sunnyvale, CA (US); Hemanth Kumar Pannem, Danville, CA (US)

(21) Appl. No.: 18/510,332

(22) Filed: Nov. 15, 2023

(30) Foreign Application Priority Data
Oct. 3, 2023 (WO) PCT/CN2023/123069

(51) Int. Cl. G06F 8/65; G06F 9/4401

(52) U.S. Cl. CPC G06F 8/65; G06F 9/4416

(57) ABSTRACT

Some embodiments of the invention provide, for a RAN (radio access network), a method of rapidly upgrading multiple machines distributed across multiple cell sites, each particular machine of the multiple machines executing one or more base station applications. The method downloads a second boot disk for each of the multiple machines at each of the multiple cell sites, the second boot disk including an upgraded version of a first boot disk currently used by each of the multiple machines. For each particular machine, the method (1) powers off the particular machine, (2) creates a copy of data stored by a data disk of the particular machine to preserve data stored currently on the data disk, (3) replaces the first boot disk of the particular machine with the second boot disk that is the upgraded version of the first boot disk, and (4) powers on the particular machine.

### BACKGROUND

Today, existing solutions for upgrading cell sites in a RAN (radio access network) are often laborious and time consuming. For instance, certain solutions are only able to upgrade 128 cell sites at once, and as such, 48 waves are needed to upgrade 6000+ cell sites. In addition to the multiple upgrade waves needed, it can take anywhere from 30 to 90 minutes to complete one wave. Accordingly, it requires 24-72 hours to complete upgrades of 6000+ cell sites in one market. The longer the maintenance window is required to complete an upgrade, the longer the system downtime is, the more loss of revenue it will cost the customer.

### BRIEF SUMMARY

Some embodiments of the invention provide, for a RAN (radio access network), a method of rapidly upgrading multiple machines distributed across multiple cell sites. Each particular machine executes one or more base station applications. In some embodiments, each particular machine is a virtual machine (VM) and the one or more base station applications include one or more vDUs (virtual distributed units) that execute within pods running on the VM. Each particular machine executes a local agent, in some embodiments, and the method is performed by the local agents.

For each of the multiple machines at each of the multiple cell sites, the method downloads a second boot disk that includes an upgraded version of a first boot disk currently used by each of the multiple machines. For each particular machine, the method (1) powers off the particular machine, (2) creates a copy of data stored by a data disk of the particular machine to preserve data stored currently on the data disk, (3) replaces the first boot disk of the particular machine with the second boot disk that is the upgraded version of the first boot disk, and (4) powers on the particular machine.

In some embodiments, after powering on the particular machine, the local agent executing on the particular machine sends a notification to a control plane server for the cell sites to notify the control plane server that the particular machine has been successfully upgraded. After sending the notification, in some embodiments, the local agent discards the copy of the data based on the particular machine being successfully upgraded (i.e., because the preserved data is no longer needed).

When the upgrade fails, in some embodiments, the local agent executing on the particular machine sends a notification to the control plane server to notify the control plane server that the upgrade has failed. Alternatively, in some embodiments, the local agent is unable to send any notifications to the control plane server when the upgrade fails. In some such embodiments, the control plane server determines that the upgrade for the particular machine has failed when the control plane server has not received any notification from the local agent on the particular machine after a certain amount of time.

In some embodiments, in response to the failed upgrade, the local agent receives a directive from the control plane server, and based on the directive, (1) powers off the particular machine, (2) reverts the second boot disk of the particular machine to the first boot disk of the particular machine, (3) uses the copy of the data to revert the data disk of the particular machine, (4) discards the copy of the data, and (5) powers on the particular machine. In other words, the local agent reverts the particular machine back to its state before the upgrade was performed, according to some embodiments. The directive is received from the control plane server, in some embodiments, via a management server for the cell sites. In some embodiments, the control plane server also directs the local agents to perform the upgrades via the management server.

In some embodiments, the local agent downloads the second boot disk for the particular machine in response to receiving a message from the control plane server that indicates the second boot disk has been uploaded to a datastore of the particular cell site and that directs the local agent to download the second boot disk from the datastore. The control plane server of some embodiments uploads the second boot disk to the datastore after receiving an API (application programming interface) call that defines an upgrade plan and an upgrade bundle for upgrading the multiple cell sites. The upgrade plan of some embodiments includes an upgrade preparation window that defines a period of time for the control plane server to upload the second boot disk to datastores at the cell sites, and one or more upgrade maintenance windows defined for the cell sites for the local agents to upgrade their respective particular machines at their respective cell sites, while the upgrade bundle includes the second boot disk.

The first boot disk of some embodiments includes an operating system (OS), a runtime component, and CVE (common vulnerabilities and exposures) patches, while the second boot disk of some embodiments includes an upgraded OS, an upgraded runtime component, and upgraded CVE patches. In some embodiments, the data stored by the data disk includes a current configuration file for the particular machine and a set of current runtime data for the particular machine.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates an example of RAN deployment of some embodiments in a 5G open RAN (O-RAN).

FIG. 2 conceptually illustrates a process performed in some embodiments to upgrade a particular VM at a particular cell site.

FIGS. 3-6 conceptually illustrate a set of diagrams that show an example of a workflow of some embodiments for orchestrating a worker node upgrade at multiple edge sites.

FIG. 7 illustrates a configuration sample of an upgrade plan of some embodiments.

FIG. 8 illustrates a configuration sample of an edge site that is associated with and defines an upgrade bundle and upgrade plan of some embodiments.

FIG. 9 illustrates a configuration sample of edge site profile intent that is used to define the upgrade bundle and other common settings for edge sites, in some embodiments.

FIG. 10 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide, for a RAN (radio access network), a method of rapidly upgrading multiple machines distributed across multiple cell sites. Each particular machine executes one or more base station applications. In some embodiments, each particular machine is a virtual machine (VM), and the one or more base station applications include one or more vDUs (virtual distributed units) that execute within pods running on the VM. Each particular machine executes a local agent, in some embodiments, and the method is performed by the local agents.

For each of the multiple machines at each of the multiple cell sites, the method downloads a second boot disk that includes an upgraded version of a first boot disk currently used by each of the multiple machines. For each particular machine, the method (1) powers off the particular machine, (2) creates a copy of data stored by a data disk of the particular machine to preserve data stored currently on the data disk, (3) replaces the first boot disk of the particular machine with the second boot disk that is the upgraded version of the first boot disk, and (4) powers on the particular machine.

In some embodiments, after powering on the particular machine, the local agent executing on the particular machine sends a notification to a control plane server for the cell sites to notify the control plane server that the particular machine has been successfully upgraded. After sending the notification, in some embodiments, the local agent discards the copy of the data based on the particular machine being successfully upgraded (i.e., because the preserved data is no longer needed).

When the upgrade fails, in some embodiments, the local agent executing on the particular machine sends a notification to the control plane server to notify the control plane server that the upgrade has failed. Alternatively, in some embodiments, the local agent is unable to send any notifications to the control plane server when the upgrade fails. In some such embodiments, the control plane server determines that the upgrade for the particular machine has failed when the control plane server has not received any notification from the local agent on the particular machine after a certain amount of time.

In some embodiments, in response to the failed upgrade, the local agent receives a directive from the control plane server, and based on the directive, (1) powers off the particular machine, (2) reverts the second boot disk of the particular machine to the first boot disk of the particular machine, (3) uses the copy of the data to revert the data disk of the particular machine, (4) discards the copy of the data, and (5) powers on the particular machine. In other words, the local agent reverts the particular machine back to its state before the upgrade was performed, according to some embodiments. The directive is received from the control plane server, in some embodiments, via a management server for the cell sites. In some embodiments, the control plane server also directs the local agents to perform the upgrades via the management server.

In some embodiments, the local agent downloads the second boot disk for the particular machine in response to receiving a message from the control plane server that indicates the second boot disk has been uploaded to a datastore of the particular cell site and that directs the local agent to download the second boot disk from the datastore. The control plane server of some embodiments uploads the second boot disk to the datastore after receiving an API (application programming interface) call that defines an upgrade plan and an upgrade bundle for upgrading the multiple cell sites. The upgrade plan of some embodiments includes an upgrade preparation window that defines a period of time for the control plane server to upload the second boot disk to datastores at the cell sites, and one or more upgrade maintenance windows defined for the cell sites for the local agents to upgrade their respective particular machines at their respective cell sites, while the upgrade bundle includes the second boot disk.

The first boot disk of some embodiments includes an operating system (OS), a runtime component, and CVE (common vulnerabilities and exposures) patches, while the second boot disk of some embodiments includes an upgraded OS, an upgraded runtime component, and upgraded CVE patches. In some embodiments, the data stored by the data disk includes a current configuration file for the particular machine and a set of current runtime data for the particular machine.

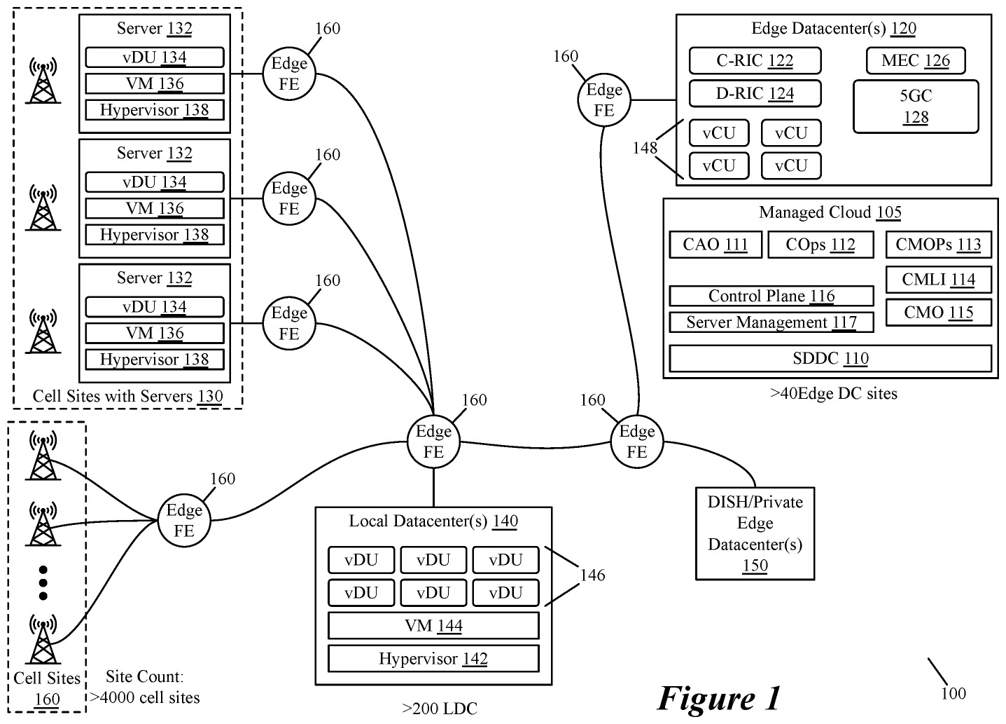

FIG. 1 conceptually illustrates an example of RAN deployment 100 of some embodiments in a 5G open RAN (O-RAN). As shown, the RAN deployment includes edge datacenter(s) 120, a managed cloud 105, cell sites with servers 130, local datacenter(s) 140, private edge datacenter(s) 150, and cell cites 160. Each of the edge datacenters 120, private edge datacenters 150, local datacenters 140, cell sites with servers 130, and cell sites 160 are connected to the RAN by the edge FEs (forwarding elements) 160. The edge FEs 160 of some embodiments are edge routers. In some embodiments, the local datacenters 140 include more than 200 local datacenters, and the cell sites 160 include more than 4000 cell sites.

The managed cloud 105 is used to manage edge datacenters of the RAN deployment 100. As shown, the managed cloud 105 includes an SDDC (software-defined datacenter) 110, a cloud automation orchestrator 111, cloud operations module 112, cloud management operations module 113, cloud management log insight module 114, cloud management orchestrator 115, control plane 116, and management server instance 117. In some embodiments, the managed cloud 105 manages more than 40 edge datacenter sites. An example of a managed cloud of some embodiments is VMware Cloud (VMC) on Amazon Web Services (AWS).

The SDDC 110 is deployed on dedicated, bare-metal hosts (i.e., dedicated hardware), in some embodiments, along with a set of standard components (e.g., hypervisors, management server, networking and security services, storage virtualization software, etc.). In addition to the management server deployed along with the SDDC 110, the management server instance 117 is deployed as part of the managed cloud 105 is used to manage resources of the managed cloud 105, in some embodiments. An example of a management server instance used in some embodiments is a vCenter server instance from VMware, Inc.

The control plane 116 of the managed cloud 105 manages the lifecycle of node clusters (e.g., clusters of VMs) deployed in the RAN deployment 100, in some embodiments. The node clusters, in some embodiments, are clusters of VMs that execute pods in which one or more applications run. The control plane 116 is used to upgrade existing clusters deployed in the RAN deployment 100, in some embodiments, as will be further described below. In some embodiments, the control plane 116 is a Tanzu Control Plane that uses TKGI (Tanzu Kubernetes Grid Integration) APIs to view cluster plans, create clusters, view cluster information, obtain credentials for deploying workloads to clusters, scale clusters, delete clusters, and create and manage network profiles for SDN (software-defined networking) solutions that enable network virtualization (e.g., NSX-T from VMware, Inc.).

The cloud automation orchestrator 111 of some embodiments is a unified orchestrator that onboards and orchestrates workloads from VM and container-based infrastructures for adaptive service-delivery foundations. In some embodiments, the cloud automation orchestrator 111 distributes workloads from the core to the edge, and from private to public clouds for unified orchestration. An example of a cloud automation orchestrator used in some embodiments is VMware, Inc.'s Telco Cloud Automation (TCA).

The cloud operations module 112 of some embodiments is used to supply automated management insights such as intelligent, automated root-cause and impact analysis; event correlation; and discovery and modeling of IT (information technology) environments being monitored (e.g., the edge datacenter sites managed by the managed cloud 105). In some embodiments, the cloud operations module 112 is used to ensure consistent service levels for applications and services delivered from the SDDC 110. An example of a cloud operations module of some embodiments is VMware, Inc.'s Telco Cloud Operations (TCO).

The cloud management orchestrator 115 is a virtual appliance that provides an automation platform for automating various infrastructure tasks using workflows, in some embodiments. The cloud management log insight module 114 of some embodiments is a highly scalable log management solution that provides intelligent log management for infrastructure and applications across the RAN deployment 100. In some embodiments, the cloud management operations module 113 provides operations management across physical, virtual, and cloud environments associated with the RAN deployment 100. Examples of the cloud management orchestrator 115, cloud management log insight module 114, and cloud management operations module 113 used in some embodiments respectively include the vRealize Orchestrator (VRO) from VMware, Inc., the vRealize Log Insight (VRLI) from VMware, Inc., and vRealize Operations (vROPs) from VMware, Inc.

The TCA for the RAN relies on TKG (Tanzu Kubernetes Grid) CAPI/CAPV (Cluster API/Cluster API Provider vSphere) to create Kubernetes clusters on cell sites, according to some embodiments. TKG uses a management cluster that takes requests from a client CLI (command-line interface) or UI (user interface) and executes them using Cluster API (i.e., a standard open-source tool for low-level infrastructure and Kubernetes cluster operations).

The edge datacenter(s) 120 includes a cRIC (centralized RAN intelligent controller (RIC)) 122, a dRIC (distributed RIC) 124, MEC (multi-access edge computing) module 126, a 5G core 128, and multiple vCUs (virtual centralized units) 148. Each dRIC 124 is a real-time or near-real-time RIC, while each cRIC 122 is a non-real-time RIC, according to some embodiments. Each RIC serves as a platform on which RAN applications (e.g., xApps for dRICs or rApps for cRICs) execute. The RAN applications, in some embodiments, are provided by third-party suppliers that are different from the RIC vendors. The RICs also serve as a communication interface between the RAN applications executed by the RICs and E2 nodes connected to the RICs, according to some embodiments.

E2 nodes that connect to the RICs include CUs (centralized units) and DUs (distributed units). In some embodiments, the CUs are vCUs such as the vCUs 148 deployed to edge datacenters 120, and the DUs are vDUs (virtual DUs) deployed to local datacenters 140 (e.g., the vDUs 146 of the local datacenters 140). Also, in some embodiments, the CUs can include the central unit control plane (CU-CP) and/or the central unit user plane (CU-UP). The CU-CP hosts RRS and the control plane aspect of the PDCP (Packet Data Convergence Protocol) protocol. The CU-CP also terminates the E1 interface connected with the CU-UP, and the F1-C interface connected with the DU. The CU-UP hosts the user plane aspect of the PDCP and the SDAP (Service Data Adaptation Protocols). Additionally, the CU-UP terminates the E1 interface connected with the CU-CP and the F1-U interface connected with the DU. In some embodiments, when the RAN is an O-RAN (open RAN), the CUs are O-CUs (open CUs) and the DUs are O-DUs (open DUs). An O-RAN is a standard for allowing interoperability of RAN elements and interfaces.

The MEC module 126 performs near-real-time processing of large amounts of data produced by edge devices (e.g., edge FEs 160) and applications closest to where the data is captured (i.e., extends the edge of an edge network infrastructure). The 5G core 128 is the heart of the 5G O-RAN network, according to some embodiments, and controls both data plane and control plane operations. In some embodiments, the 5G core 128 aggregates data traffic, communicates with UE (user equipment), delivers essential network services, provides extra layers of security, etc.

Each local datacenter 140, in some embodiments, includes a hypervisor 142 that executes at least one VM 144. The VM 144 is deployed as a worker node, in some embodiments, to execute containerized applications. In some embodiments, the containerized applications execute within pods that execute on the VM 144. For example, the vDUs 146 each execute in a respective pod (not shown) on the VM 144. The hypervisor 142 of some embodiments runs directly on the computing hardware of a host computer (not shown), while in other embodiments, the hypervisor 142 runs within the operating system of the host computer (not shown).

The cell sites with servers 130 includes multiple servers 132 for each of the multiple cell sites. Each cell site with a server 130 is referred to as a leaf node, in some embodiments. Like the local datacenters 140, each leaf node server 132 includes a hypervisor 138 that executes a VM 136 for running one or more pods to execute at least one vDU 134.

In some embodiments, each 5G cell site (e.g., cell sites with servers 130 and cell sites 160) includes a single VM (virtual machine) that is exclusively created on a physical host computer. The VM is deployed as a worker node (e.g., Kubernetes worker node), in some embodiments, and runs a single vDU application (e.g., runs one or more pods that execute the single vDU application). In some embodiments, it is critical to keep the clusters (i.e., clusters of worker node VMs) up to date with security patches and bug fixes to ensure business continuity. Regular updates, particularly those with CVE patches, will protect the workloads from security vulnerabilities and failures, according to some embodiments.

As such, some embodiments of the invention provide a faster upgrade strategy for upgrading multiple cell sites connected by a RAN, as also mentioned above. The upgrade strategy of some embodiments is used to upgrade worker nodes (e.g., Kubernetes worker nodes) deployed at each cell site for executing base station applications (e.g., vDUs) and CNFs.

In some embodiments, the worker nodes are VMs that each include a boot disk and a data disk. The boot disk (BP) includes a boot partition, an immutable OS, system packages required by the telecommunications network (e.g., Telco), container network binaries (e.g., Kubernetes network binaries such as kubeadm, kubelet, containerd, cri, etc.), embedded image caches, etc. The data disk is used to store configuration files and runtime data. In some embodiments, the upgrade strategy is performed by swapping the A/B boot disk while protecting the data disk in case of failure.

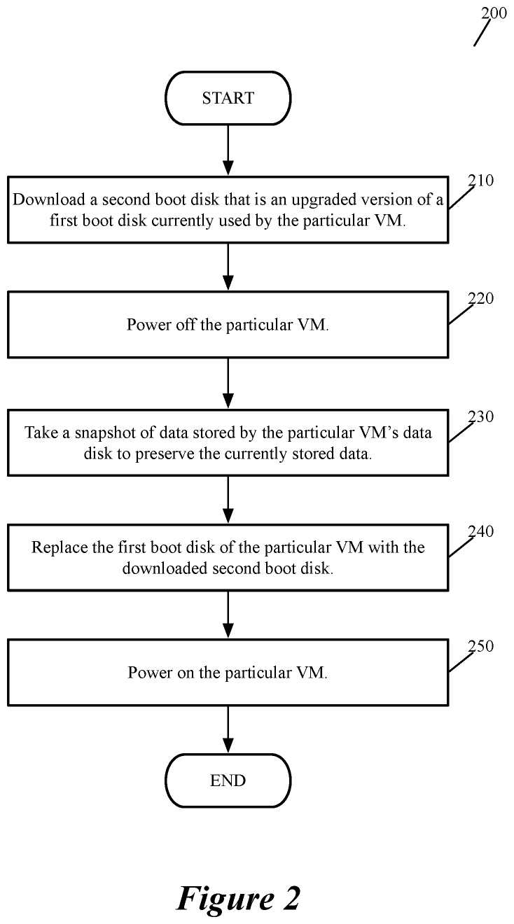

FIG. 2 conceptually illustrates a process 200 performed in some embodiments to upgrade a particular VM at a particular cell site. The process 200 is performed in some embodiments by a local agent (e.g., local control plane agent) deployed to the particular VM. The process 200 starts when the local agent downloads (at 210) a second boot disk that is an upgraded version of a first boot disk currently used by the particular VM. As described above, the local agent of some embodiments downloads the second boot disk from a datastore at the cell site to which the control plane sever has uploaded the second boot disk. Also, in some embodiments, the local agent performs the download upon receiving instructions from the control plane server to perform the download (e.g., during the upgrade plan's defined upgrade preparation window).

The process 200 powers off (at 220) the particular VM, and takes (at 230) a snapshot of data stored by the particular VM's data disk to preserve the currently stored data. The currently stored data of the data disk, in some embodiments, includes current configuration files and current runtime data. Taking the snapshot (i.e., a copy of the data) allows the data to be preserved in case the upgrade fails and the data disk needs to be restored to its state from before the upgrade.

The process 200 replaces (at 240) the first boot disk of the particular VM with the downloaded second boot disk. That is, the first boot disk is swapped out for the second (i.e., upgrade) boot disk. In some embodiments, the first boot disk includes an OS, a runtime component, and CVE patches, while the second boot disk of some embodiments includes an upgraded OS, an upgraded runtime component, and upgraded CVE patches. After the boot disks have been swapped, the process 200 powers on (at 250) the particular VM. Following 250, the process 200 ends.

In some embodiments, as also described above, the local agents notify the control plane server of either a successful or unsuccessful upgrade, and when the upgrade is unsuccessful, the control plane server of some embodiments directs the local agent to revert the upgrade (i.e., swap the second boot disk for the first boot disk and revert the data disk using the snapshot). Additional details regarding the fast upgrade of multiple cell sites will be further described below.

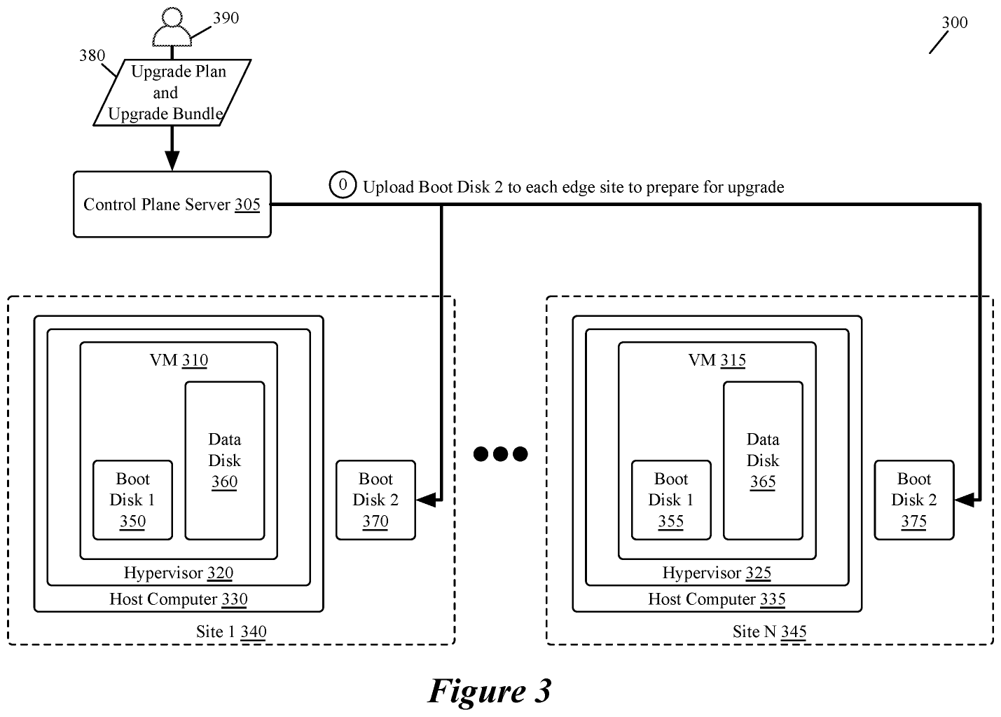

FIGS. 3-6 conceptually illustrate a set of diagrams that show an example of a workflow of some embodiments for orchestrating a worker node upgrade at multiple edge sites. FIG. 3 conceptually illustrates a first diagram 300 of the workflow of some embodiments. As shown, the diagram 300 includes a control plane server 305 that is an edge site control plane for edge site 1 340 through edge site N 345. Each edge site 340-345 includes a respective host computer 330 and 335 that executes a respective hypervisor (e.g., virtualization software) 320 and 325 on top of which a respective VM (e.g., worker node) 310 and 315 runs. Each VM 310 and 315 includes a respective boot disk 350 and 355 as well as a respective data disk 360 and 365.

From an administrator 390 of the edge sites 340-345, the control plane server 305 receives an API call 380 that defines an upgrade plan and an upgrade bundle location. The upgrade plan, in some embodiments, defines an upgrade preparation window (e.g., a time window during which the control plane server 305 can upload the upgrade package for the edge sites) and upgrade maintenance window (e.g., a time window defined for each site during which the control plane server 305 can perform the upgrade for that site), while the upgrade bundle includes an upgraded boot disk for upgrading the edge sites 340-345. The upgraded boot disk includes a new operating system, new container network runtime binaries (e.g., Kubernetes runtime binaries), and CVE patches.

During the upgrade preparation window, the control plane server 305 uploads the upgrade bundle (i.e., the upgraded boot disk) to a datastore (not shown) of each edge site 340-345, as illustrated as step “0” in the diagram 300. After step “0”, all edge sites 340-345 associated with the control plane server 305 have the upgraded boot disk 370 and 375 ready. The control plane server 305 then waits for the maintenance window defined for each edge site 340-345 to perform the upgrades.

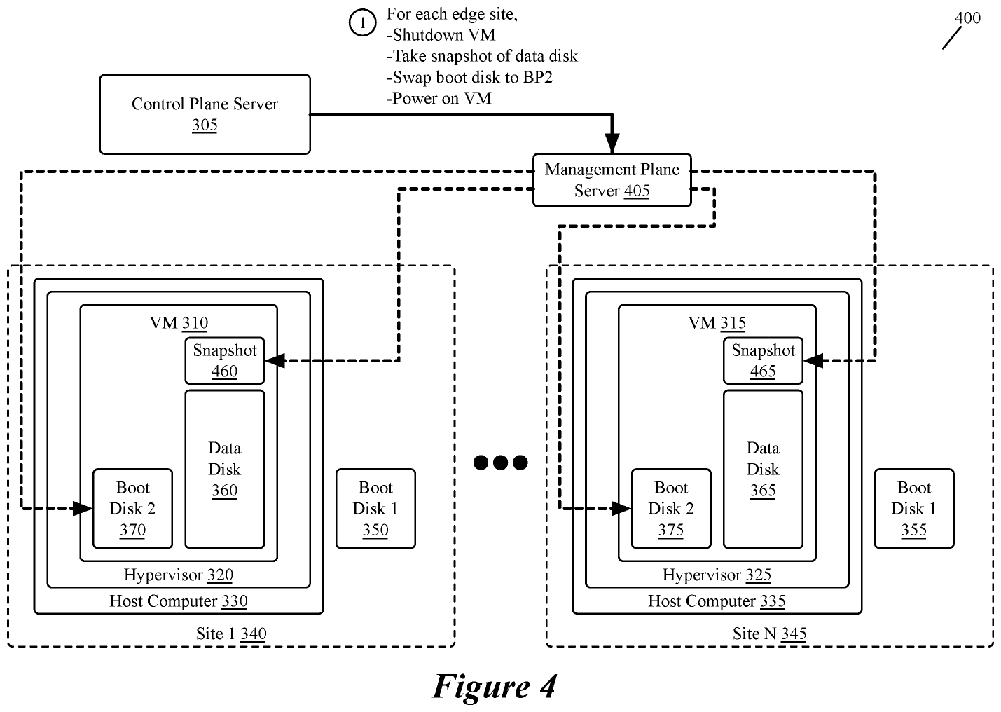

FIG. 4 conceptually illustrates a second diagram 400 of the workflow of some embodiments. When the maintenance window arrives, the control plane server 305 triggers the upgrade actions, at the encircled “1”, to a management plane server 405 for edge sites associated with the maintenance window. For each associated edge site VM 310 and 315, the management plane server 405 performs a set of upgrade actions that include (1) shutting down the VM, (2) taking a snapshot of the VM's data disk (e.g., making a copy of the data stored by the data disk), (3) swapping out the current boot disk (e.g., boot disks 1 350 and 355) for the upgraded boot disk (e.g., boot disks 2 370 and 375), and (4) powering on the VM. By taking snapshots 460 and 465 of the data stored by the data disks 360 and 365, the management and control plane servers 305 and 405 ensure the stored data is protected during the boot disk swaps.

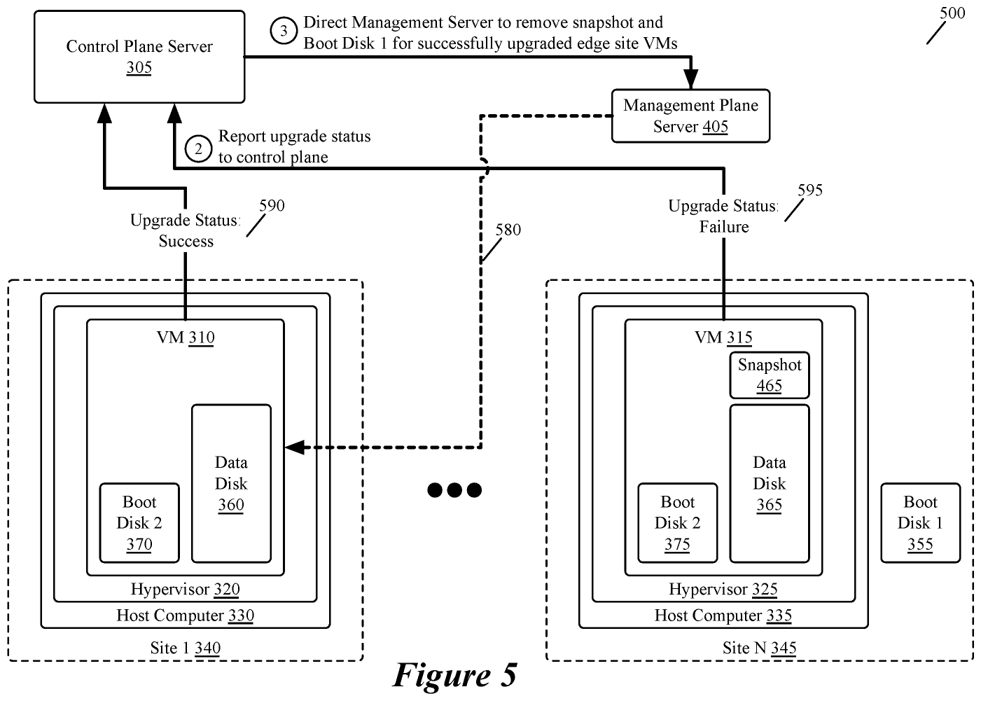

FIG. 5 conceptually illustrates a third diagram 500 of the workflow of some embodiments. In some embodiments, after the upgrade has been performed, each edge site VM 310-315 sends a report to the control plane server 305 to indicate to the control plane server 305 whether the upgrade of the edge site VM 310-315 was successful. The reports are sent, in some embodiments, by node agents (not shown) that are deployed to each edge site VM 310-315.

For example, the VMs 310 and 315 report their upgrade statuses at the encircled step “2” by sending respective upgrade statuses 590 and 595 to the control plane server 305. As shown, the VM 310 reports an upgrade status 590 as successful, while the VM 315 reports an upgrade status 595 as failure. As an alternative to the report 395 that indicates upgrade failure for the edge site VM 315, the control plane server 305 of some embodiments determines that the upgrade for an edge site has failed when the control plane server 305 has not received any report from that edge site following a certain duration of time (e.g., as specified by an administrator).

In some embodiments, for edge sites that are upgraded successfully, the control plane server 305 triggers a post-upgrade action to remove the data disk snapshot for the edge site VM of that edge site. For instance, at the encircled step “3” in the diagram 500, the control plane server 305 directs the management plane server 405 to remove the snapshot and the boot disk 1 for each successfully upgraded edge site VM. Accordingly, as indicated by the arrow 580, the management plane server 405 has removed the snapshot and boot disk 1 for the edge site 340.

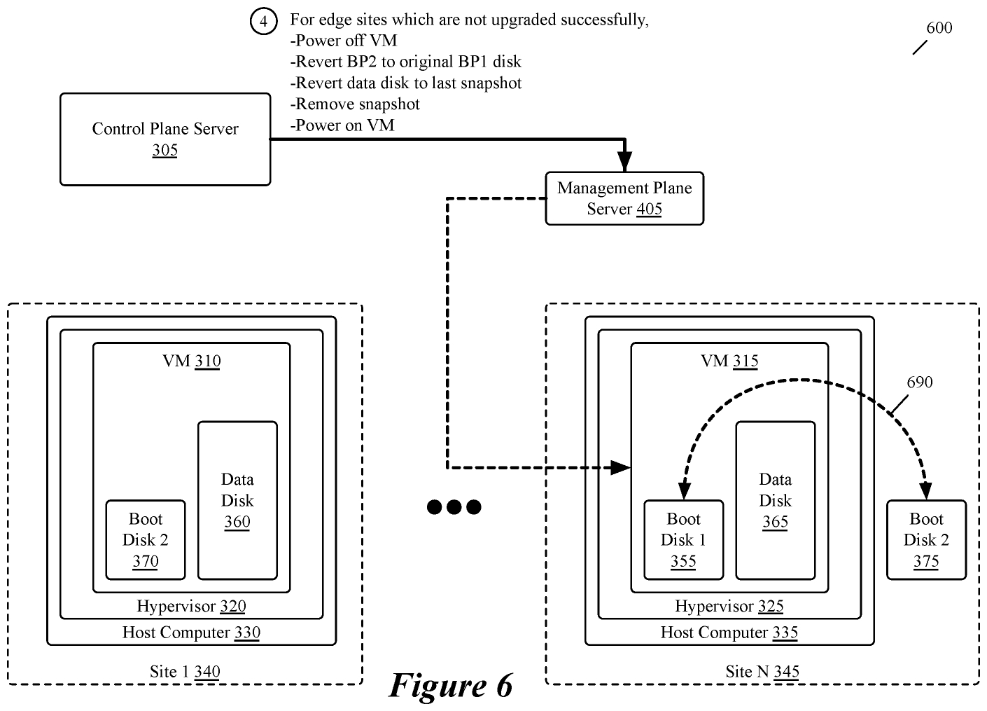

FIG. 6 conceptually illustrates a fourth diagram 600 of some embodiments. For edge sites that report upgrade failures (e.g., the edge site node status is indicated as failure, or has not been updated for a certain duration of time and thus indicates failure), the control plane server 305 triggers post-upgrade recovery actions to recover the edge site. For example, in the diagram 600, the control plane server 305 triggers the post-upgrade actions to the management plane server 405 at the encircled step “4”.

The recovery actions of some embodiments include (1) powering off the VM, (2) reverting the upgraded boot disk (e.g., the boot disk 2 375) to the original boot disk (e.g., the boot disk 1 355), (3) reverting the data disk (e.g., data disk 365) to the last snapshot, (4) removing the last snapshot, and (5) powering on the VM. In the diagram 600, the management plane server 405 performs the recovery actions to revert the data disk 365 and swap the boot disks as indicated by the dashed line 690. After the recovery actions have been performed, the powered on VM 315 includes the boot disk 1 355 and its data disk 365 has been restored to the last snapshot.

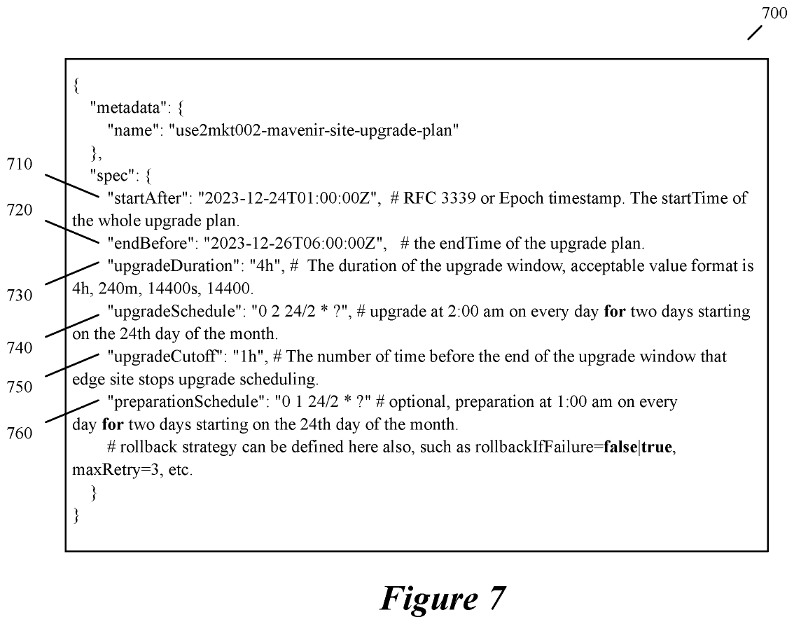

In some embodiments, the upgrade plan and upgrade bundle for an edge site are defined in a declarative manner. FIG. 7 illustrates a configuration sample 700 of an upgrade plan of some embodiments. The sample 700 includes multiple key value pairs. In the sample 700, the key “startAfter” 710 is used to define the start time value of upgrade plan. In some embodiments, acceptable values for the start time are a time represented by the RFC 3339 or Epoch timestamp (e.g., 2023-12-24T01: 00:00Z, 2023-12-24T09: 00:00-08:00, 1703379600). In addition to “startAfter” 710, additional time-related key-value pairs defined in the upgrade plan include the key “endBefore” 720 for defining the end time value of the upgrade plan, the key “upgradeDuration” 730 for defining the time duration value of the upgrade window, and the key “upgradeSchedule” 740 for defining the cron job (UTC) value to schedule the upgrade task.

In some embodiments, one or more upgrade windows are defined in an upgrade plan. If an upgrade is missed in the first defined upgrade window, each subsequent upgrade window defined in the upgrade plan can be used until the upgrade has been successfully completed, or until all upgrade windows have passed. In some embodiments, the key “upgradeCutoff” 750 is an optional key-value pair that is used to define a value associated with an amount of time before the end of the upgrade window at which the edge site is to stop upgrade task scheduling. For example, if the cutoff is set to 1 hour, the upgrade start time is 2:00 a.m., and the end time is 6:00 a.m., the upgrade will be skipped if the preparation stage is not completed before 5:00 a.m. (i.e., one hour before the end time).

Another optional time-related key-value pair used in some embodiments is the key “preparationSchedule” 760, which is used to define the preparation start time value before the upgrade window. In some embodiments, “preparationSchedule” 760 is used for the node agent deployed to the edge site VM to download the upgrade bundle and to perform other upgrade preparation steps. The “preparationSchedule” 760 does not interrupt the CNF operating, in some embodiments, but introduces some management network delays, in some embodiments.

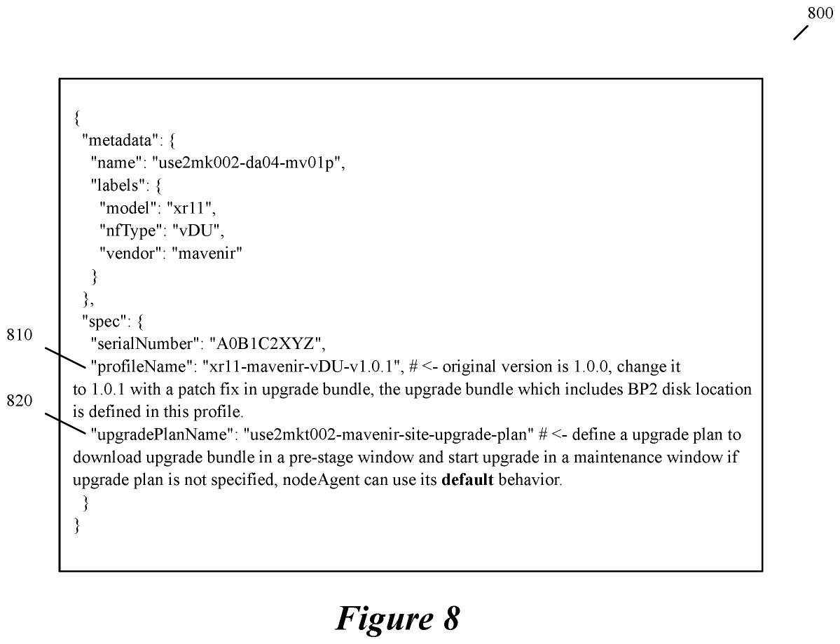

FIG. 8 illustrates a configuration sample 800 of an edge site that is associated with and defines an upgrade bundle and upgrade plan of some embodiments. As shown, the sample 800 includes multiple key-value pairs, such as a profile name key-value pair 810 and an upgrade plan name key-value pair 820. The profile name key-value pair 810 specifies a key, “profileName”, and a defined value, “xr11-mavenir-vDU-v1.0.1”. As illustrated, the original version is 1.0.0 and should be changed to 1.0.1 with a patch fix in the upgrade bundle, and the upgrade bundle includes the upgrade boot disk (i.e., “BP2”) location defined for the specified profile. The upgrade plan name key-value pair 820 specifies a key, “upgradePlanName”, and a defined value, “use2mkt002-mavenir-site-upgrade-plan”, and indicates to define an upgrade plan to download the upgrade bundle in a pre-stage window (e.g., step “0” described above by FIG. 3) and start the upgrade in a maintenance window, and, if an upgrade plan is not specified, that the node agent (i.e., the node agent deployed to the edge site VM) can use its default behavior. In some embodiments, the default behavior of the node agent is to trigger the upgrade immediately when an upgrade plan is not specified.

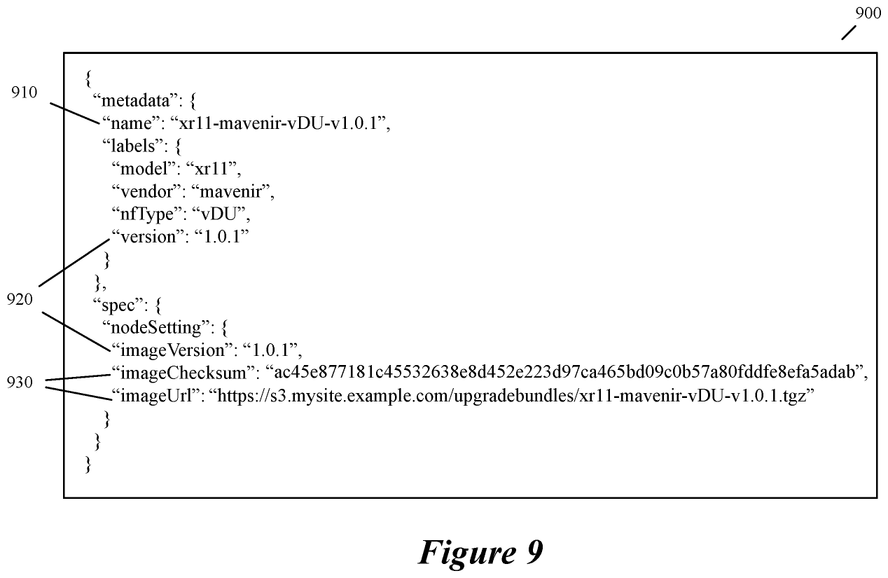

FIG. 9 illustrates a configuration sample 900 of edge site profile intent that is used to define the upgrade bundle and other common settings for edge sites, in some embodiments. The sample 900 specifies key-value pairs such as a name of the edge site profile 910, version and image version 920, and an image checksum and image URL 930 for the upgrade bundle. The edge site profile name is the same as the value shown for the profile name key-value pair 810 described above: “xr11-mavenir-vDU-v1.0.1”. Similarly, the version and image version “1.0.1” defined in the sample 900 matches the version in the name in this sample 900 as well as in the sample 800 above. Lastly, the image URL specifies a location of the upgrade bundle for this edge site profile.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

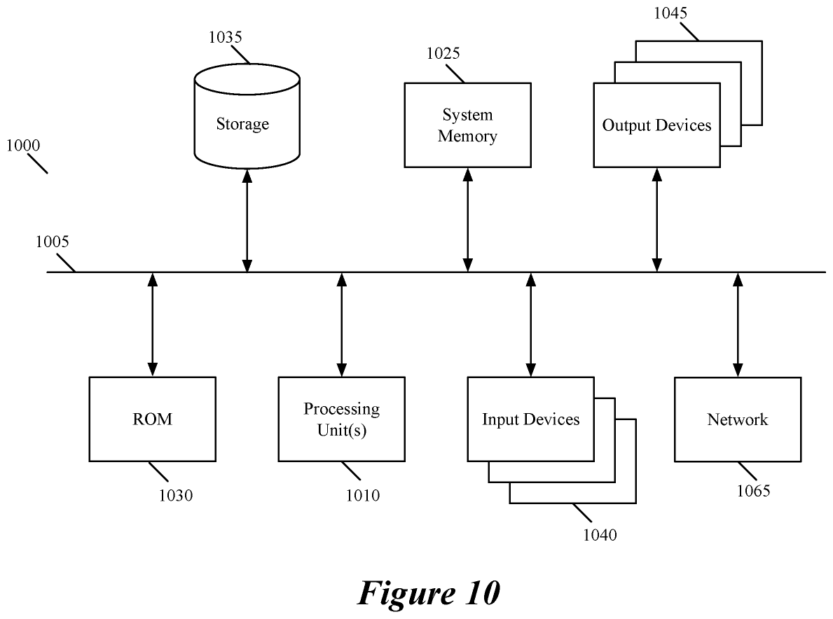

FIG. 10 conceptually illustrates a computer system 1000 with which some embodiments of the invention are implemented. The computer system 1000 can be used to implement any of the above-described computers and servers. As such, it can be used to execute any of the above described processes. This computer system includes various types of non-transitory machine readable media and interfaces for various other types of machine readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments. The read-only-memory (ROM) 1030 stores static data and instructions that are needed by the processing unit(s) 1010 and other modules of the computer system. The permanent storage device 1035, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a flash drive, etc.) as the permanent storage device. Like the permanent storage device 1035, the system memory 1025 is a read-and-write memory device. However, unlike storage device 1035, the system memory is a volatile read-and-write memory, such a random access memory. The system memory stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. For a RAN (radio access network), a method of rapidly upgrading a plurality of machines distributed across a plurality of cell sites, each particular machine of the plurality of machines executing one or more base station applications, the method comprising:
downloading a second boot disk for each of the plurality of machines at each of the plurality of cell sites, the second boot disk comprising an upgraded version of a first boot disk currently used by each of the plurality of machines; and
for each particular machine:
powering off the particular machine;
creating a copy of data stored by a data disk of the particular machine to preserve data stored currently on the data disk;
replacing the first boot disk of the particular machine with the second boot disk that is the upgraded version of the first boot disk; and
powering on the particular machine.

2. The method of claim 1, wherein each particular machine executes a local agent, wherein the method is performed for each particular machine by the local agent of the particular machine.

3. The method of claim 2, further comprising:
sending a notification to a control plane server for the plurality of cell sites, the notification indicating the particular machine has been successfully upgraded; and
discarding the copy of the data based on the particular machine being successfully upgraded.

4. The method of claim 3, wherein downloading the second boot disk for the particular machine comprises receiving a message from the control plane server that (i) indicates the second boot disk has been uploaded to a datastore of the particular cell site and (ii) directs the local agent to download the second boot disk from the datastore.

5. The method of claim 4, wherein the control plane server uploads the second boot disk to the datastore of the particular cell site after receiving an API (application programming interface) call that defines an upgrade plan and an upgrade bundle for upgrading the plurality of cell sites, the upgrade bundle comprising the second boot disk.

6. The method of claim 5, wherein the upgrade plan comprises (i) an upgrade preparation window that defines a period of time for the control plane server to upload the second boot disk to datastores at the plurality of cell sites, and (ii) one or more upgrade maintenance windows defined for the plurality of cell sites for the local agents to upgrade their respective particular machines at their respective cell sites.

7. The method of claim 6, wherein the control plane server (i) uploads the second boot disk to datastores at the plurality of sites during the upgrade preparation window and (ii) directs the local agents to upgrade their respective particular machines during the one or more upgrade maintenance windows defined for the plurality of cell sites.

8. The method of claim 2, wherein when upgrading the particular machine fails, the method further comprises:
sending a notification to a control plane server for the plurality of cell sites, the notification indicating upgrading the particular machine has failed;
powering off the particular machine;
reverting the second boot disk of the particular machine to the first boot disk of the particular machine;
using the copy of the data to revert the data disk of the particular machine;
discarding the copy of the data; and
powering on the particular machine.

9. The method of claim 8, wherein said powering off, reverting, using, discarding, and powering are performed after receiving a directive from the control plane server in response to the notification to perform said powering, reverting, using, discarding, and powering on.

10. The method of claim 9, wherein receiving the directive from the control plane server comprises receiving the directive from the control plane server via a management server for the plurality of cell sites.

11. The method of claim 1, wherein the second boot disk comprises (i) an upgraded operating system (OS), (ii) an upgraded runtime component, and (iii) upgraded CVE (common vulnerabilities and exposures) patches.

12. The method of claim 1, wherein the data stored by the data disk comprises a current configuration file for the particular machine and a set of current runtime data for the particular machine.

13. The method of claim 1, wherein the particular machine comprises a particular virtual machine (VM) executing on a particular host computer.

14. The method of claim 13, wherein the one or more base station applications executed by the particular VM are executed within pods running on the particular VM.

15. The method of claim 14, wherein the one or more base station applications comprises one or more vDUs (virtual distributed units).

16. For a RAN (radio access network), a non-transitory machine readable medium storing a program for execution by a set of processing units, the program for rapidly upgrading a plurality of machines distributed across a plurality of cell sites, each particular machine of the plurality of machines executing one or more base station applications, the program comprising sets of instructions for:
downloading a second boot disk for each of the plurality of machines at each of the plurality of cell sites, the second boot disk comprising an upgraded version of a first boot disk currently used by each of the plurality of machines; and
for each particular machine:
powering off the particular machine;
creating a copy of data stored by a data disk of the particular machine to preserve data stored currently on the data disk;
replacing the first boot disk of the particular machine with the second boot disk that is the upgraded version of the first boot disk; and
powering on the particular machine.

17. The non-transitory machine readable medium of claim 16, wherein each particular machine executes a local agent, wherein the sets of instructions are performed for each particular machine by the local agent of the particular machine.

18. The non-transitory machine readable medium of claim 17, the program further comprising sets of instructions for:
sending a notification to a control plane server for the plurality of cell sites, the notification indicating the particular machine has been successfully upgraded; and
discarding the copy of the data based on the particular machine being successfully upgraded.

19. The non-transitory machine readable medium of claim 18, wherein:
the control plane server receives an API (application programming interface) call that defines an upgrade plan and an upgrade bundle comprising the second boot disk for upgrading the plurality of cell sites and uploads the second boot disk to a datastore of each particular cell site to be downloaded by the local agent on the particular machine at the particular cell site based on the receive API call; and
the upgrade plan comprises (i) an upgrade preparation window that defines a period of time for the control plane server to upload the second boot disk to datastores at the plurality of cell sites, and (ii) one or more upgrade maintenance windows defined for the plurality of cell sites for the local agents to upgrade their respective particular machines at their respective cell sites.

20. The non-transitory machine readable medium of claim 17, wherein when upgrading the particular machine fails, the program further comprises sets of instructions for:
sending a notification to a control plane server for the plurality of cell sites, the notification indicating upgrading the particular machine has failed;
powering off the particular machine;
reverting the second boot disk of the particular machine to the first boot disk of the particular machine;
using the copy of the data to revert the data disk of the particular machine;
discarding the copy of the data; and
powering on the particular machine.
